(19) United States
(12) Patent Application Publication
(10) Pub. No.: US 2013/0336185 A1
(43) Pub. Date: Dec. 19, 2013

(54) APPARATUS AND METHOD FOR RECHARGE-TRIGGERED WAKE-UP FOR POWER MANAGEMENT IN WIRELESS SENSOR NETWORKS

(71) Applicant: The Research Foundation for the State University of New York, Albany, NY (US)

(72) Inventors: Yuanyuan YANG, East Setauket, NY (US); Cong Wang, Stony Brook, NY (US)

(21) Appl. No.: 13/921,622

(22) Filed: Jun. 19, 2013

Related U.S. Application Data
(60) Provisional application No. 61/661,648, filed on Jun. 19, 2012.

(51) Int. Cl. H04W 52/02

(52) U.S. Cl. CPC H04W 52/028
USPC 370/311

(57) ABSTRACT

Disclosed is a wireless sensor network that includes a plurality of wireless sensor nodes having a sensor, a sensor activation switch, a memory having a data buffer, an energy harvester, a capacitor switching bank having more than one switch, a capacitor bank having a corresponding number of capacitors, a wireless interface, and a controller. The capacitor switching bank is provided between the capacitor bank and the energy harvester, and the energy harvester provides power to charge capacitors of the plurality of capacitors connected by the capacitor switching bank.

### PRIORITY

This application claims priority to U.S. Provisional Application No. 61/661,648, filed Jun. 19, 2012, the entire content of which is incorporated herein by reference.

### GOVERNMENT SUPPORT

This invention was made with government support under grant number ECCS0801438 awarded by the National Science Foundation and grant number W911NF-09-1-0154 awarded by the Department of the Army. The government has certain rights in the invention.

### BACKGROUND OF THE INVENTION

1. Field of the Invention

The present invention relates to a Wireless Sensor Node (WSN) and network of WSNs, in particular, a method for wake up and use of WSNs in wireless sensor networks.

2. Description of the Related Art

A wireless sensor network generally consists of a group of wirelessly connected sensor nodes, often used to remotely monitor environmental conditions, such as temperature and movement, target detection, tracking, and other activity. Conventional wireless sensor networks include networks that include a large number of low-power sensors scattered in a designated area. When the sensors are deployed in hostile territory or inconvenient locations, sensor retrieval and battery replacement is difficult or impossible.

Two general conventional methods exist to manage energy usage in wireless sensor networks having widely deployed sensors. The first method applies a predefined duty cycle to periodically wake up the sensors, sense an environmental condition, and transmit data regarding the sensed environmental condition. However, the duty cycle method can result in excessive and undesired delay between wake ups, resulting in failure to obtain complete and/or timely information regarding the sensed environmental condition. The duty cycle method does not prevent unnecessary wake up of one or more sensor nodes, thereby wasting energy.

The second method is an on-demand sensor wake-up. The on-demand method is typically radio-triggered, using a predefined wake-up signal that wakes one or more sensors. Significant drawbacks of the on-demand method are a limited operating distance and a delay for the sensor node(s) to fully awaken. Sensor nodes are also prone to yield false decisions after receiving the wake-up signal due to multi-path wireless channel fading and associated radio signal corruption.

Accordingly, a need exists for a sensor node that can remotely operate and tailor energy use to device operation parameters of the sensor node, while avoiding loss of sensor functionality due to excess sleep cycle or wake-up delay.

### SUMMARY OF THE INVENTION

The present invention overcomes the above shortcoming of conventional methods and systems, and provides a method that optimizes use of harvested ambient energy to maximize time that each sensor remains awake.

A wireless sensor network is provided that includes a plurality of wireless sensor nodes each having at least one sensor, a sensor activation switch, a memory having a data buffer, an energy harvester, a capacitor switching bank having more than one switch, a capacitor bank having a corresponding number of capacitors, a wireless interface, and a controller. The capacitor switching bank is provided between the capacitor bank and the energy harvester, and the energy harvester provides power to charge capacitors of the plurality of capacitors connected by the capacitor switching bank.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 illustrates a distributed Wireless Sensor Network (WSN) in which the wireless sensor nodes of the present invention operate;

FIG. 2 illustrates components of a wireless sensor node of the present invention;

FIG. 3 provides a detailed view of a capacitor switching bank and a capacitor bank of the present invention;

FIGS. 4a-4b illustrate total power stored over time for various arrangements of a plurality of switches of the capacitor switching bank of FIG. 3; and

FIG. 5 is a flow diagram of a method of the present invention.

### DETAILED DESCRIPTION OF THE EMBODIMENTS

The following detailed description of embodiments of the invention will be made with reference to the accompanying drawings. In describing the preferred embodiments, explanation of related functions or constructions known in the art are omitted for the sake of clarity in understanding the concept of the invention that would otherwise obscure the invention with unnecessary detail.

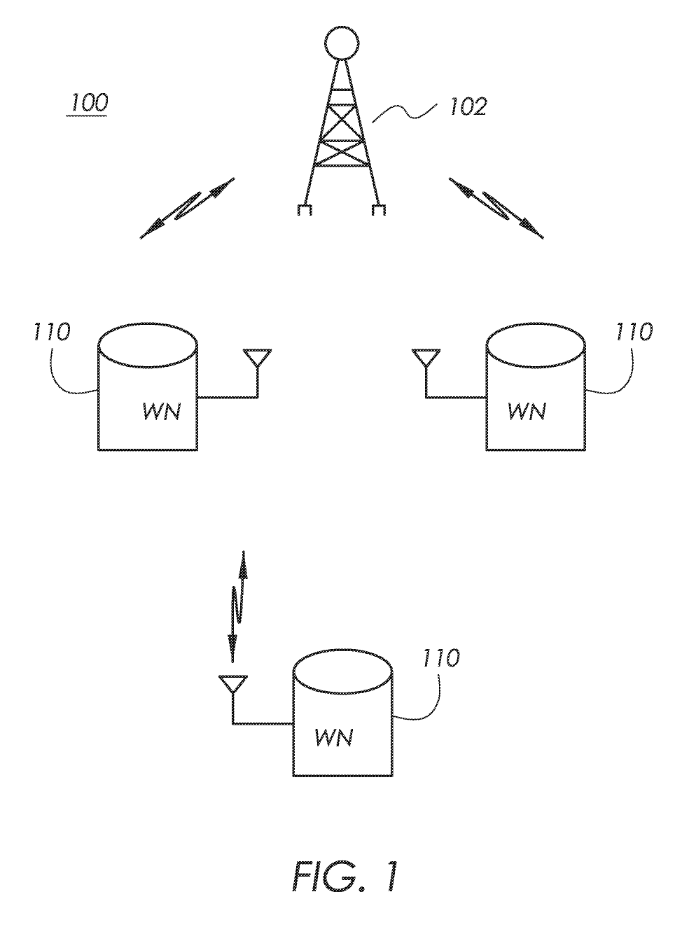

In a preferred embodiment, a Wireless Sensor Network (WSN) 100 is provided that includes a plurality of wireless sensor nodes 110 and a central receiver 102, as shown in FIG. 1.

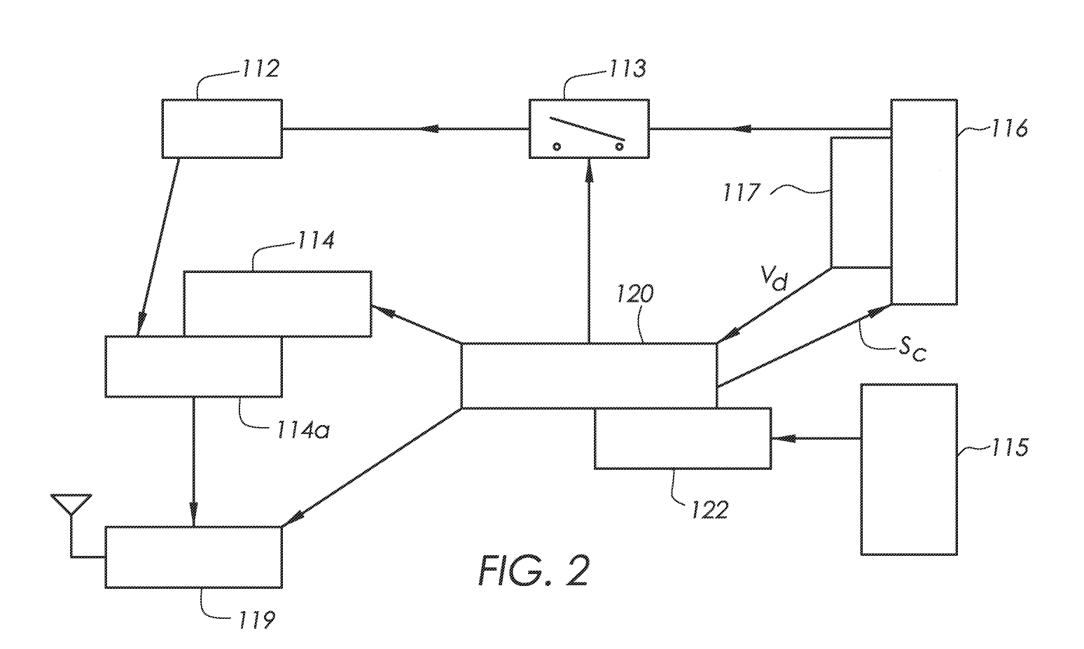

FIG. 2 illustrates components of wireless sensor node 110, which includes a sensor 112, which can include a plurality of sensors, a memory 114, which preferably includes a data buffer 114a, an energy harvester 115, a wireless interface 119, and a controller 120.

The sensor 112 of the wireless sensor node 110 is configured to monitor one or more desired environmental conditions. For example, sensor 112 preferably includes a temperature probe to monitor temperature changes, a motion detector, and a camera for target detection and tracking. Sensor 112 may also include a radio frequency identification tag reader and a license plate reader, and is configured to accept input from other sensors that a user can add to the wireless sensor node 110.

The wireless interface 119 of wireless sensor node 110 includes a communication unit and communication adapter configured to operate under instruction from controller 120, either in a point to point communication mode, a point to multipoint communication mode, a broadcast communication mode, and/or an ad hoc mode via multi hop networking.

The controller 120 of wireless sensor node 110 includes a computer processor to perform the above-described operations and to control the overall operation of wireless sensor node 110. The controller 120 interfaces with and controls wake up and powering off of sensor 112, as well as operation of memory 114.

Controller 120 of wireless sensor node 110 includes a processor configured to execute the programs run in an automated format, by one or more processors, e.g., with one or more steps being conducted on a first processor, while other steps being conducted on a second processor, with the processors located in a same physical space or distantly located. In certain embodiments, multiple processors are linked over an electronic communications network, such as the Internet. Preferred embodiments include processors associated with a display device for showing the results of the methods to a user or users, outputting results as a video image of a predicted crystal structure that include coordinates of atoms, molecules or motifs. The processors may be directly or indirectly associated with information databases, which may include police and tracking databases. As used herein, the terms processor, central processing unit, and CPU are used interchangeably and refer to a device that is able to read a program from a computer memory, e.g., Read Only Memory (ROM) or other computer memory, and perform a set of steps according to the program. The terms computer memory and computer memory device refer to any storage media readable by a computer processor. Examples of computer memory include, but are not limited to, Random Access Memory (RAM), ROM, computer chips, digital video discs, compact discs, hard disk drives and magnetic tape. Also, computer readable medium refers to any device or system for storing and providing information, e.g., data and instructions, to a computer processor, DVDs, CDs, hard disk drives, magnetic tape and servers for streaming media over networks. As used herein, the term encode refers to the process of converting one type of information or signal into a different type of information or signal to, for example, facilitate the transmission and/or interpretability of the information or signal. For example, image files can be converted into, i.e., encoded into, electrical or digital information. Likewise, light patterns can be converted into electrical or digital information that provides and encodes video capture of the light patterns.

Energy harvester 115 outputs to power to operate sensor 112 of sensor node 110, thereby facilitating remote operation in areas lacking a separate or reliable power supply, and eliminating the need to access the sensor node 110 for battery replacement. Energy harvester 115 also preferably provides a direct recharge of a controller battery 122 provided solely for operation of controller 120. Energy harvester 115 can convert Radio Frequency (RF) power captured by a receiving antenna and/or solar power captured by photovoltaic cells, and convert the power to Direct Current (DC) via a rectifier, as known to those of skill in the art. See, U.S. Publ. No. 2008/0143192 A1 to Sample et al. and U.S. Publ. No. 2012/0293021 A1 to Teggatz et al.

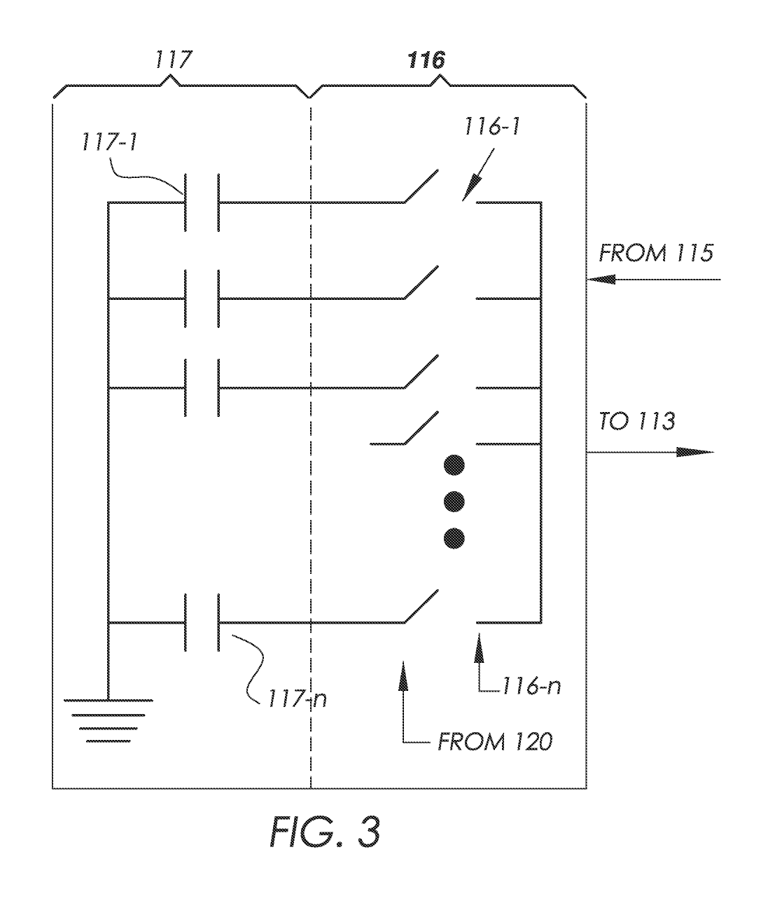

As shown in FIG. 3, capacitor bank 117 includes a plurality of parallel connected capacitors 117-1 to 117-n, with a first end of each of the plurality of capacitors 117-1 to 117-n receiving power from energy harvester 115 and a second end of each of the plurality of capacitors 117-1 to 117-n connected to ground. Capacitor switching bank 116 is provided between the capacitor bank 117 and energy harvester 115. As shown in FIG. 3, switching bank 116 includes a plurality of switches 116-1 to 116-n, each controlled by controller 120, for connecting respective capacitors to an output of energy harvester 115.

Power output from energy harvester 115 charges each capacitor of the plurality of capacitors 117-1 to 117-n connected via respective switches 116-1 to 116-n of capacitor switching bank 116. Accordingly, a total amount of power that can be stored by capacitor bank 117 depends on a total number of the plurality of capacitors 117-1 to 117-n connected via switches 116-1 to 116-n of capacitor switching bank 116.

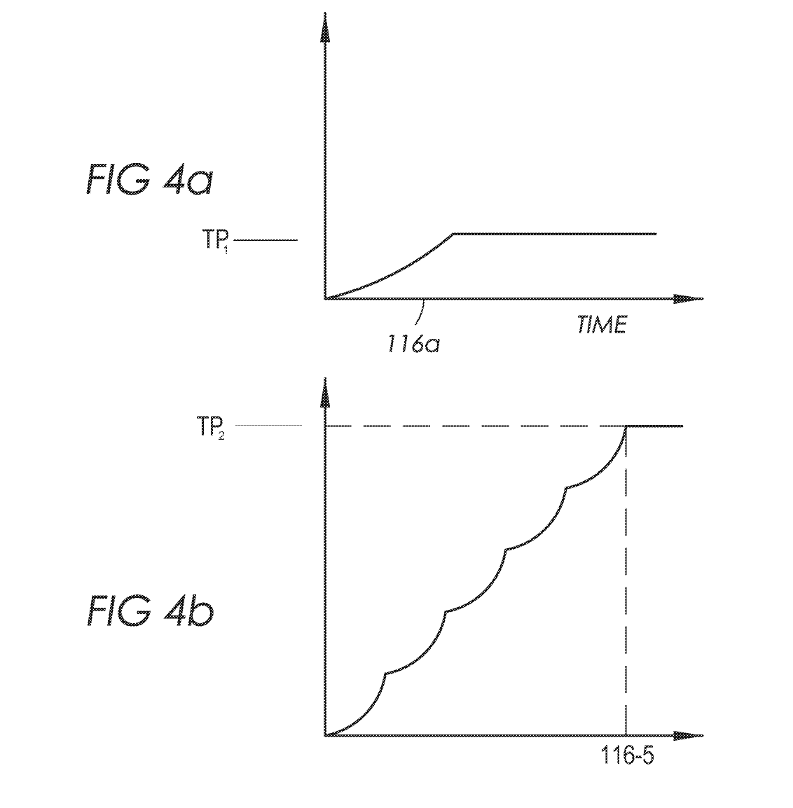

FIGS. 4a-4b illustrate total power stored over time for various arrangements of the plurality of switches 116-1 to 116-n of capacitor switching bank 116. FIG. 4a shows a first level of total power (TP₁) stored when only one switch 116-1 connects one capacitor 117-1 to energy harvester 115. As shown in FIG. 4a, the total amount power to be stored is quickly accumulated, in comparison to the switch settings of FIG. 4b. FIG. 4b shows a second level of total power (TP₂) stored when five switches 116-1 to 116-5 connect five capacitors 117-1 to 117-5 to energy harvester 115. As shown in FIG. 4b, additional time is required to store the total power, but a greater amount of total power is stored.

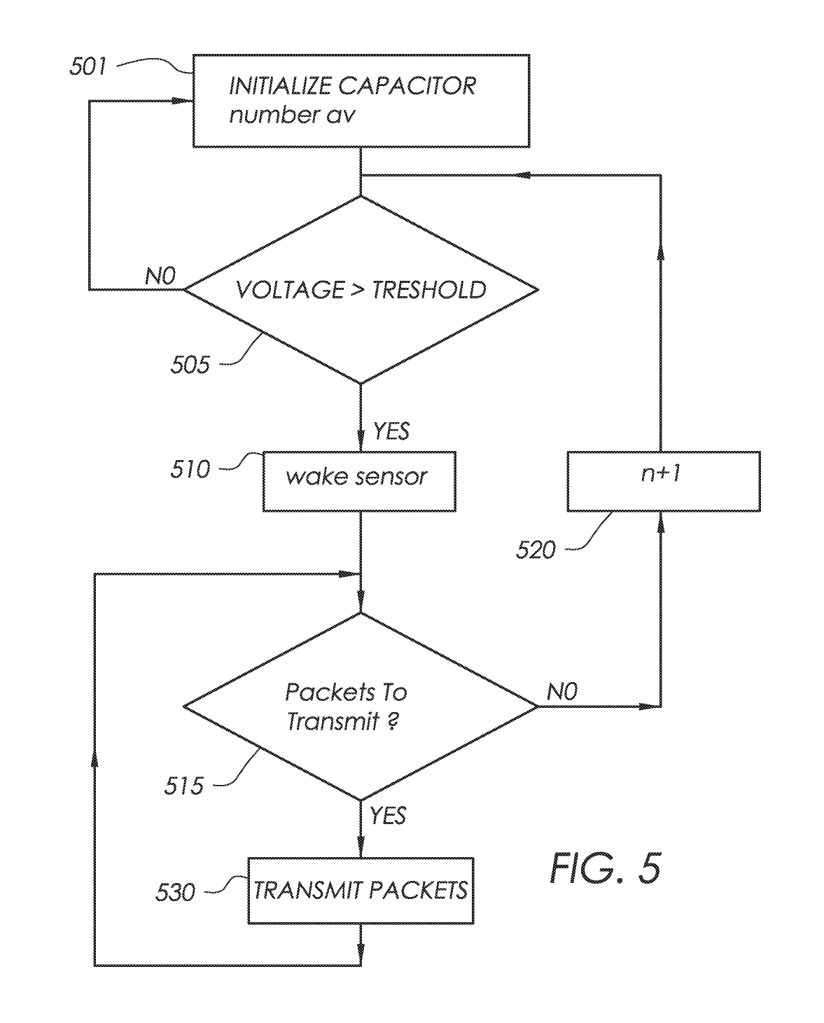

As shown in FIG. 2, a switch control (S_{c}) is provided from controller 120 to capacitor switching bank 116. The switch control (S_{c}) operates each of the various switches of the plurality of switches 116-1 to 116-n, as described in FIG. 5.

In a default mode, as shown in FIG. 4a and described above, one switch 116-1 of the plurality of switches of the capacitor switching bank 116 is closed, with the remaining switches being in an open state. This default mode initializes a total number of connected capacitors as one, as shown in Step 501 of FIG. 5.

A measurement of capacitor voltage is then provided, via voltage detection line (V_{D}, FIG. 2), to controller 120. If in Step 505, the measured capacitor voltage does not exceed a threshold voltage, preferably 1.25V, the method returns to initialization Step 501.

If in Step 505, the measured capacitor voltage is determined to exceed a threshold voltage, sensor 112 is awoken by controller 120 closing a sensor activation switch 113, thereby providing power to sensor 112, in Step 510. Opening sensor activation switch 113 powers off sensor 112.

In Step 515 a determination is made of whether data packets are present in buffer 114a. If not, the method proceeds to Step 520, in which the number of total switches of the plurality of switches that are closed in capacitor switching bank 116 is increased by one, i.e. switches 116-1 and 116-2 are closed, and the method returns to the Step 505 to determine whether the measured capacitor voltage exceeds the threshold voltage.

If in Step 515 date packets are determined to be present in buffer 114a, the method proceeds to Step 530 in which wireless interface 119 is activated and the packets are transferred to interface 119 for transmission, with Step 515 repeated until each data packet is transmitted. As shown in FIGS. 4a-4b, increasing the total number of switches of the plurality of switches of capacitor switching bank 116 that are closed results in a greater amount of total power being stored in capacitor bank 117, and extends the time for capacitor bank 117 to reach the total power, as measured by voltage detection line (V_{D}).

Accordingly, a wireless sensor network 100 is provided that includes a plurality of wireless sensor nodes 110. Each wireless sensor node of the wireless sensor network 100 includes a sensor 112, a sensor activation switch 113, a memory 114 with a data buffer 114a, an energy harvester 115, a capacitor switching bank 116 including a plurality of switches 116-1 to 116-n, a capacitor bank 117 including a plurality of capacitors 117-1 to 117-n, a wireless interface 119, and a controller 120. The capacitor switching bank 116 is provided between the capacitor bank 117 and the energy harvester 115, and the energy harvester 115 provides power to charge those capacitors that are connected by the capacitor switching bank 116. In the wireless sensor network, the capacitor bank 117 includes a plurality of parallel connected capacitors for receiving power from the energy harvester 115, and the switching bank includes a plurality of switches for connecting respective capacitors of the plurality of parallel connected capacitors to an output of the energy harvester 115. The wireless sensor network the plurality of switches of the capacitor switching bank 116 are each controlled by controller 120, and the energy harvester 115 captures one of Radio Frequency (RF) power and solar power. The controller 120 powers on the sensor 112 when a measured capacitor voltage exceeds a threshold voltage. In addition, if data packets are determined to be present in the buffer 114a, the wireless interface 119 is activated and the data packets are transferred to interface 119 for transmission until data packets are determined to no longer be present in buffer 114a.

Accordingly, an improved sensor node trigger method is provided that ensures an amount of energy available in capacitor bank 117 to ensure completion of the desired sensing of a predetermined environmental condition, to maximize performance, enable fast initiation, provide a reduced packet delay, and allow for near perpetual network lifetime operation and energy savings over conventional sensor wake-up techniques. The wireless sensor node can be implemented using low-cost, readily available hardware devices and is adaptable for a wide range of applications.

While the invention has been shown and described with reference to certain embodiments of the present invention thereof, it will be understood by those skilled in the art that various changes in form and details may be made therein without departing from the spirit and scope of the present invention as defined by the appended claims and equivalents thereof.

What is claimed:

1. A wireless sensor network including a plurality of wireless sensor nodes, each of the plurality of wireless sensor nodes comprising:
a sensor;
a sensor activation switch;
a memory including a data buffer;
an energy harvester;
a capacitor switching bank;
a capacitor bank including a plurality of capacitors;
a wireless interface; and
a controller,
wherein the energy harvester charges one or more capacitors of the plurality of capacitors, as connected by the capacitor switching bank.

2. The wireless sensor network of claim 1, wherein the plurality of capacitors of the capacitor bank are connected in parallel.

3. The wireless sensor network of claim 1, wherein the capacitor switching bank is provided between the capacitor bank and the energy harvester.

4. The wireless sensor network of claim 3, wherein the capacitor switching bank includes a plurality of switches for connecting respective capacitors to the energy harvester.

5. The wireless sensor network of claim 4, wherein the plurality of switches of the capacitor switching bank are controlled by controller.

6. The wireless sensor network of claim 1, wherein the energy harvester captures one of Radio Frequency (RF) power and solar power.

7. The wireless sensor network of claim 1, wherein the sensor receives power when the controller determines that a measured capacitor voltage exceeds a threshold voltage.

8. The wireless sensor network of claim 1, wherein, if data packets are determined to be present in the buffer, the wireless interface is activated and the data packets are transferred to the wireless interface for transmission.

9. The wireless sensor network of claim 8, wherein, if data packets are determined not to be present in the buffer, a number of total switches of the plurality of switches of capacitor switching bank that are closed is increased.
